(19) United States
(12) Patent Application Publication
(10) Pub. No.: US 2015/0257506 A1
(43) Pub. Date: Sep. 17, 2015

(54) Hair Protective Head Garment and Method of Making

(71) Applicants: Blaire Brown, Phoenixville, PA (US); Jordan Wallace, Washington, DC (US)

(72) Inventors: Blaire Brown, Phoenixville, PA (US); Jordan Wallace, Washington, DC (US)

(21) Appl. No.: 14/635,322

(22) Filed: Mar. 2, 2015

Related U.S. Application Data
(60) Provisional application No. 61/953,754, filed on Mar. 15, 2014.

(51) Int. Cl. A45D 19/18; A61Q 5/12

(52) U.S. Cl. CPC A45D 19/18; A61Q 5/12

(57) ABSTRACT

A head garment has a satin lining, sewn into the interior, to create a barrier that is necessary to keep hair moisturized. Hair will never touch the harsh materials of the hat. The hat comprises of an acrylic or polyester exterior also; a 95% polyester and 5% spandex interior comprising of different material finishes. The hat fits snugly around the head due to a thin elastic band.

### CROSS-REFERENCE TO RELATED APPLICATION

This application claims priority from U.S. Provisional Patent Application Ser. No. 61/953,754, filed Mar. 15, 2014, which is incorporated by reference herein in its entirety.

### FIELD OF THE INVENTION

The present invention relates to hair care, hair protection, and maintenance. The inventive head garment is designed to protect against breakage of hair, “hat hair” and dryness.

### BACKGROUND OF THE INVENTION

Women with a naturally dry texture of hair need to go above and beyond to keep their hair moisturized and healthy. For many women, this consists of wearing a bonnet or scarf at night to keep hair protected from the harsh materials their hair may come into contact with, such as cotton. Typical hats are made from harsh materials but are necessary for both style and protection. Weather is a serious factor that can cause damage and breakage to hair from the cold, dry air as well as the beaming sunlight. During the winter, hats are used to keep warm and during the summer, hats are used to block the sun; during both times protection is still needed.

When bonnets are worn under hats, there is always the possibility of the bonnet accidentally showing or having difficulties taking the bonnet and the hat off at the same time. A head garment that eliminates the additional step and adds the “bonnet” to the hat is required.

### BRIEF SUMMARY OF THE INVENTION

Briefly, the present invention provides a head covering including a single sheet of an exterior fabric material and a single sheet of interior fabric material fixedly attached to the exterior fabric material, forming a hat material assembly. The hat material assembly has a base and a top portion, the top portion forming a plurality of arches. Each of the plurality of arches is connected to an adjacent of the plurality of arches, forming a dome.

Further, the present invention provides a method of making the head covering, as well as a head covering manufactured by the method.

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain the features of the invention. In the drawings:

FIG. 1 is a perspective view of a bolt of fabric that is cut to form an exterior portion of a hat according to an exemplary embodiment of the present invention;

FIG. 2 is a top plan view of the fabric after having been cut;

FIG. 3 is a top plan view of the cut fabric shown in FIG. 2, with a liner sewn thereon;

FIG. 4A is a perspective view of the fabric/liner shown in FIG. 4, being folded across a first central lateral axis;

FIG. 4B is a perspective view of the fabric/liner shown FIG. 4A, being folded across a second central lateral axis;

FIG. 4C is a perspective view of the fabric/liner shown in FIG. 4B, after being folded;

FIG. 5 is a perspective view of the folded fabric/liner shown in FIG. 4C, with a template secured to the top thereof;

FIG. 6 is a perspective view of the folded fabric/liner shown FIG. 5, being cut along the template;

FIG. 7 is a top plan view of the fabric/liner after having been cut, forming four panels;

FIG. 8 is a top plan view of the fabric/liner with an elastic material having been sewn long along a bottom edge thereof;

FIG. 9 is a perspective view showing a first panel being sewn to an adjacent panel;

FIG. 10 is a perspective view showing a fourth panel being sewn to the first panel; and

FIG. 11 shows a finished hat according to an exemplary embodiment of the present invention.

### DETAILED DESCRIPTION OF THE INVENTION

In the drawings, like numerals indicate like elements throughout. Certain terminology is used herein for convenience only and is not to be taken as a limitation on the present invention. The terminology includes the words specifically mentioned, derivatives thereof and words of similar import. The embodiments illustrated below are not intended to be exhaustive or to limit the invention to the precise form disclosed. These embodiments are chosen and described to best explain the principle of the invention and its application and practical use and to enable others skilled in the art to best utilize the invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

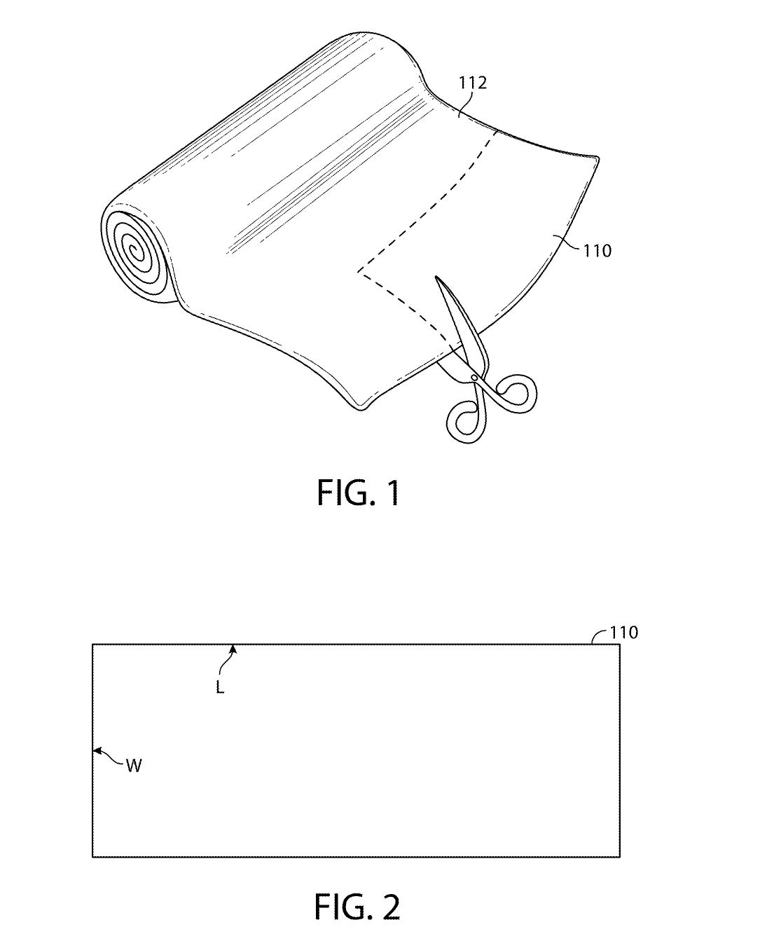

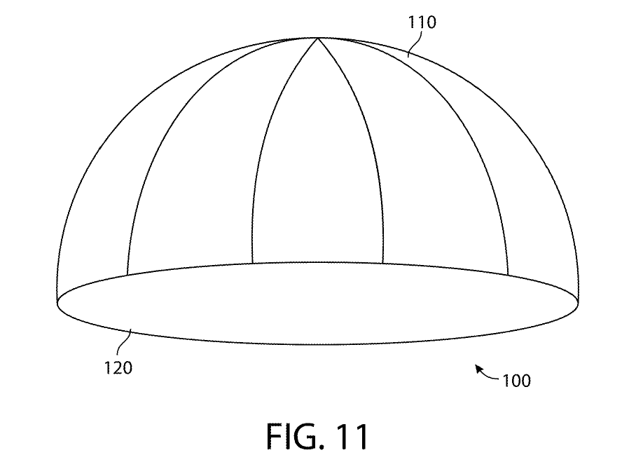

Referring to the figures, a hat 100 (shown in FIG. 11) according to an exemplary embodiment of the present invention is shown. As shown FIG. 1, hat 100 includes an exterior material 110. Exterior material 110 may be constructed from a fabric material that may be suitable for the exterior of a hat, such as, for example, an acrylic material, although those skilled in the art will recognize that exterior material 110 may be constructed from other materials as well. Exterior material 110 can be a rectangular sheet cut from a bolt 112 of the fabric. As shown FIG. 2, cut fabric 110 has a length “L” and a width “W”. In an exemplary embodiment, length L can be about 23 inches and with W can be about 12 inches.

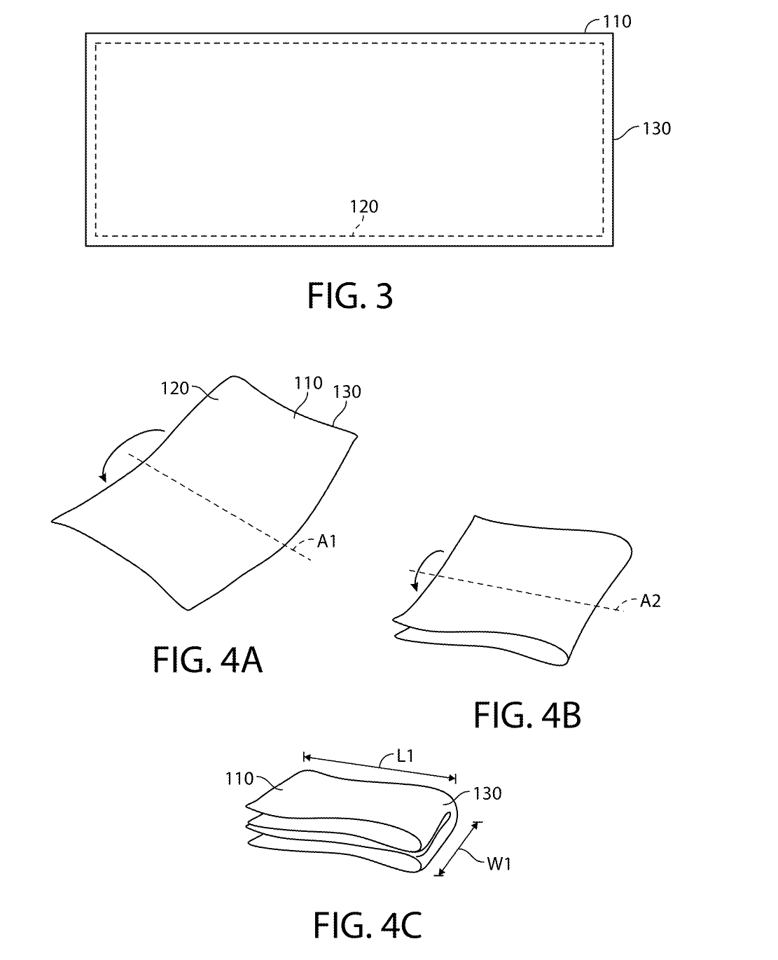

As shown in FIG. 3, an interior lining 120 is sewn along the edges of exterior material 110, forming a hat material assembly 130. In an exemplary embodiment, interior lining 120 may have a satiny finish and be a polyester/spandex blend, such as, a 95% polyester/5% spandex blend, although those skilled in the art will recognize that interior lining 120 may be other materials as well. Interior lining 120 forms a barrier that is necessary to keep hair moisturized. With interior lining 120, hair will not touch the harsh materials of exterior material 110.

As shown FIG. 4A, hat material assembly 130 is folded along a centrally located lateral axis A1, and then, as shown FIG. 4B, material assembly is folded along a centrally located axis A2, which extends parallel to lateral axis A1, resulting in material assembly 130 having four layers with dimensions “L1” and “W1”, as shown in FIG. 4C. In an exemplary embodiment, dimension L1 is the same dimension as with W, while dimension W1 is about one quarter the dimension of length L. Therefore, in an exemplary embodiment, L1 is about 12 inches and W1 is about 5⅞ inches.

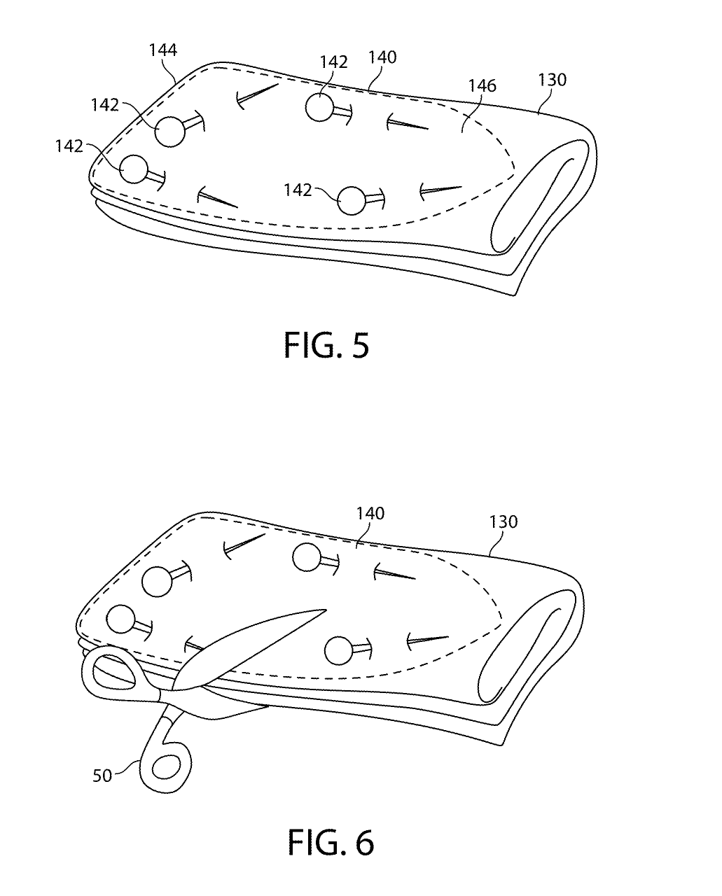

As shown in FIG. 5, a template 140 is secured to folded material assembly 130, such as, for example, by a plurality of pins 142. Template 140 has a base 144 that is the same length as dimension W1 and a maximum height that is the same dimension as dimension L1. A top portion 146 of template 140 is arched, similar to a Gothic arch.

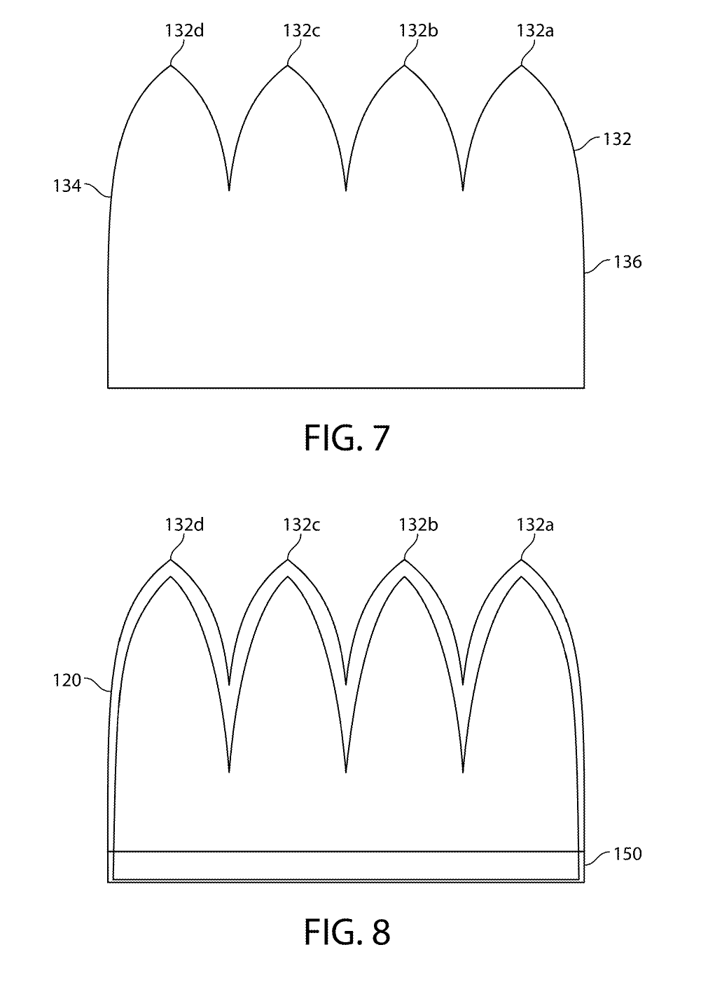

As shown in FIG. 6, scissors 50 are used to cut all four layers of folded material assembly 130 along top portion 146 of template 140. After cutting, template 140 is removed from material assembly 130, which is then unfolded to reveal a four paneled cut assembly 132 having four peaks 132a, 132b, 132c, 132d, as shown FIG. 7. Peaks 132a, 132b, 132c, 132d will form the top portion of finished hat 100.

While the folding process described above results in four layers that, when sewn together, will generate a four paneled hat, those skilled in the art will recognize that different folding processes that result in a different number of layers will generate a paneled hat with the different number of layers. For example, if, after FIG. 4A, material assembly 130 is folded in thirds, resulting in six layers, the generated hat will be a six-paneled hat.

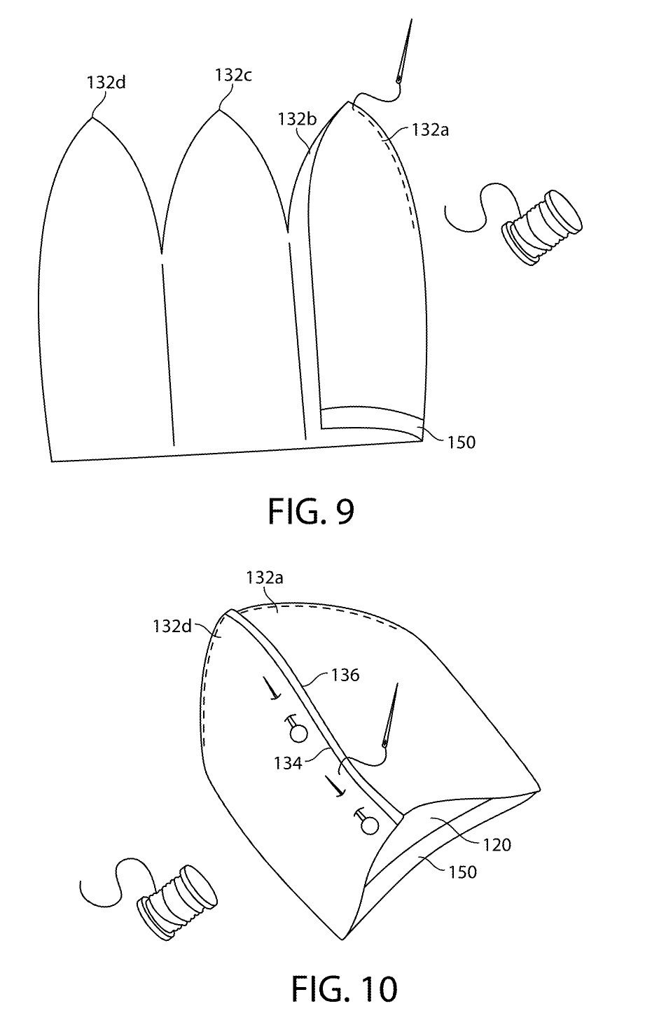

An elongate elastic material 150 is sewn along a bottom edge of cut assembly 130 over interior lining 120, distal from peaks 132a, 132b, 132c, 132d, as shown in FIG. 8. As shown FIG. 9, the panel of cut assembly 132 having peak 132a is folded over toward adjacent panel of cut assembly 132b and the portion of peak 132a that is adjacent to the portion of peak 132b are sewn together.

The process is repeated for the portion of peak 132b that is adjacent to peak 132c and for the portion of peak 132c that is adjacent to peak 132d. The unsewn length along the left side 134 of cut assembly 132 as shown FIG. 7 is then sewn to the length along the right side 136 of cut assembly 132, as shown in FIG. 10. At this point, all of peaks 132a, 132b, 132c, 132d are joined at the top of hat 100 with arched portions below peaks 132a, 132b, 132c, 132d forming a generally circular dome.

The sewn assembly is then inverted so that interior lining 120 and elastic material 150 are on the inside of hat 100 and exterior material 110 is on the exterior of hat 100.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A head covering comprising:
a single sheet of an exterior fabric material; and
a single sheet of interior fabric material fixedly attached to the exterior fabric material, forming a hat material assembly,
wherein the hat material assembly has a base and a top portion, the top portion forming a plurality of arches, and wherein each of the plurality of arches is connected to an adjacent of the plurality of arches, forming a dome.

2. The head covering according to claim 1, further comprising elastic band attached to the interior fabric material, proximate to the base.

3. The head covering according to claim 1, wherein the interior fabric material comprises a polyester/spandex blend fabric material.

4. The head covering according to claim 1, wherein the plurality of arches comprises four arches.

5. The head covering according to claim 1, wherein the interior fabric material is sewn to the exterior fabric material.

6. A method of manufacturing a head covering comprising the steps of:
(a) providing a rectangular piece of an exterior fabric material;
(b) placing a rectangular piece of an interior fabric material on top of the exterior fabric material;
(c) securing the interior fabric material to the exterior fabric material, forming a hat material assembly;
(d) folding the hat material assembly a plurality of times, forming a multi-layered hat material assembly;
(e) cutting a top portion of the hat material assembly, forming a plurality of arches; and
(f) securing each arch to an adjacent arch, forming a dome.

7. The method according to claim 6, further comprising, prior to step (f), securing an elastic material along a bottom like the hat material assembly.

8. The method according to claim 6, wherein the hat material assembly comprises a first lateral axis and wherein step (d) comprises folding the hat material assembly along the first lateral axis.

9. The method according to claim 8, wherein, after the hat material assembly is folded along the first lateral axis, the hat material assembly is folded along a second lateral axis, parallel to the first lateral axis.

10. The method according to claim 6, further comprising, between steps (d) and (e), securing a template to the hat material assembly.

11. The method according to claim 10, wherein, in step (d), the plurality of times comprises two times.

12. The method according to claim 6, further comprising, after step (e), and, prior to step (f), unfolding the hat material assembly.

13. A head covering manufactured by steps of:
(a) providing a rectangular piece of an exterior fabric material;
(b) placing a rectangular piece of an interior fabric material on top of the exterior fabric material;
(c) securing the interior fabric material to the exterior fabric material, forming a hat material assembly;
(d) folding the hat material assembly a plurality of times, forming a multi-layered hat material assembly;
(e) cutting a top portion of the hat material assembly, forming a plurality of arches; and
(f) securing each arch to an adjacent arch, forming a dome.

14. The head covering manufactured according to claim 13, further comprising, prior to step (f), securing an elastic material along a bottom like the hat material assembly.

15. The head covering manufactured according to claim 13, wherein the hat material assembly comprises a first lateral axis and wherein step (d) comprises folding the hat material assembly along the first lateral axis.

16. The head covering manufactured according to claim 15, wherein, after the hat material assembly is folded along the first lateral axis, the hat material assembly is folded along a second lateral axis, parallel to the first lateral axis.

17. The head covering manufactured according to claim 13, further comprising, between steps (d) and (e), securing a template to the hat material assembly.

18. The head covering manufactured according to claim 13, wherein, in step (d), the plurality of times comprises two times.

19. The head covering manufactured according to claim 13, further comprising, after step (e), and, prior to step (f), unfolding the hat material assembly.

20. The head covering manufactured according to claim 13, wherein the plurality of arches comprises four arches.
